(19) United States
(12) Patent Application Publication
(10) Pub. No.: US 2012/0319434 A1
(43) Pub. Date: Dec. 20, 2012

(54) VEHICLE ROOF HAVING AN INTEGRATED ROLLER BLIND

(76) Inventor: Thomas Lux, Weissach Im Tal (DE)

(21) Appl. No.: 13/581,090

(22) PCT Filed: Apr. 20, 2011
(86) PCT No.: PCT/EP2011/056289

§ 371 Date: Aug. 24, 2012

(30) Foreign Application Priority Data
Apr. 28, 2010 (EP) 10161240.6

(51) Int. Cl. B60J 7/06; B29C 45/00; B23P 17/04

(52) U.S. Cl. 296/219; 29/527.1

(57) ABSTRACT

The present disclosure relates to a vehicle roof having an integrated roller sunroof, including a vehicle roof with a roof opening, guides mounted on both sides in the longitudinal direction on opposite edges of the roof opening, ribs, domes, roller shaft receptacles and a roller blind roll in the roller shaft receptacles.

The invention relates to a motor vehicle roof with an integrated roller blind, a method for its production and its use.

Sunroofs in motor vehicles are becoming increasingly popular. The sunroofs commonly consist of an opening in the motor vehicle roof covered with a transparent pane. However, in the hot summer and with strong sunlight, the passenger compartment can heat up greatly through the roof opening. In addition, the driver can be blinded by scattered light while driving. Also, the heating up of the passenger compartment has a negative effect on the driver's ability to concentrate and to react. One possible solution is a regulatable or displaceable roller blind or Venetian blind that can be opened or closed depending on the strength and location of the incident sunlight. In particular, with a stationary vehicle, the heating up of the passenger compartment and, thus, the use of the air conditioner while driving can be significantly reduced. During cold weather, the roller blind is commonly drawn to prevent heat loss through the transparent roof.

In the wake of increasingly stringent regulations on carbon dioxide emission of cars, there are also strong efforts to reduce the weight of a motor vehicle and, thus, its fuel consumption. Constant innovations in the area of plastics enable the replacement of large portions of the metal automobile body with correspondingly lighter elements made of polymeric materials. In particular, parts or even the entire roof area can be replaced by elements made of polymeric materials. In many cases, these have, along with a significantly lower weight, comparable hardness, stability, and toughness to a vehicle body roof made of steel. Additionally, due to the weight reduction in the roof region, the center of gravity of the vehicle is moved even lower, which has a positive effect on handling. Moreover, compared to metals, polymeric materials can be produced, processed, and shaped at significantly lower temperatures. This reduces the energy demand and the costs during production of the materials.

The installation of the roller blind elements in the motor vehicle requires, even in the case of a roof made of polymeric materials, the installation of a roller blind frame by gluing or screwing multiple individual parts such as guide rails, stiffening ribs, latch elements, and roller blind mounts. However, many individual steps in roller blind installation increase the duration and expense of the installation and make production more expensive. Moreover, the large number of process steps increases the probability of disruptions and defects that can lead to production delays and increased rejects.

EP 1 285 794 A1 discloses a sun roller blind device to be disposed under a transparent roof region of a motor vehicle. The sun roller blind device can be adjusted via a winding shaft and guides mounted on the sides of the vehicle roof.

DE 20 2006 015 107 U1 discloses a guide rail for a roller blind of a sliding roof, a retaining section for attachment of the guide rail on the vehicle, and a guiding section to accommodate the roller blind. The retaining section and the guiding section are connected via a flexible spring section.

EP 0 990 544 A1 discloses a closable vehicle roof opening with a guide rail attached to the roof and a closure means mounted thereon. The guide rails are, in particular, protected against penetrating dirt.

EP 1 285 794 A1 discloses a sun roller blind device for a motor vehicle roof. The sun roller blind device has a winding shaft displaceably guided on lateral guides of the vehicle roof, which can be adjusted between a storage position and a functional position.

EP 1 782 985 A1 discloses a cover device of a glazed vehicle roof. The cover device includes a motor driven roller blind.

The object of the invention is to provide a motor vehicle roof with an integrated roller roof that can be cost-effectively manufactured from the fewest possible individual parts and has high stability.

The object of the present invention is accomplished according to the invention by a motor vehicle roof with an integrated roller sunroof according to claim 1. Preferred embodiments emerge from the subclaims.

A method according to the invention for producing a motor vehicle roof and its use emerge from other coordinated claims.

The motor vehicle roof with an integrated roller sunroof according to the invention comprises a motor vehicle roof with a roof opening made of a polymeric material. The invention preferably also includes vehicle roofs in which only a portion of the vehicle body roof has been replaced by a vehicle roof made of polymeric materials. Guides, ribs (strips), domes, roller blind locking means, and roller blind shaft holders are attached on the edge of the roof opening opposite each other on the right and left, either in the driving direction or counter to the driving direction of the vehicle. The number of domes and guides, ribs (strips), domes, roller blind locking means, and roller blind shaft holders is not specified and can be varied. Preferably, at least two guides, two ribs, two roller blind shaft holders, and two domes are attached on the motor vehicle roof. A roller blind roller is situated in the two roller blind shaft holders. Wound on the roller blind roller is a roller blind that can be rolled up and unrolled along the guides and bounded by the ribs and can thus open and close the roof opening in the motor vehicle roof. On the two edges of the roller blind that are inserted in the guides and against the ribs, sliding blocks are preferably affixed. The sliding blocks enable preferably flexible mounting, displaceable in position, of the roller blind on the guides and against the ribs. The arrangement described is closed by covers on the roller blind shaft holders, the guides, the ribs, and the variable number of domes. The domes preferably include in their interior a thread or material for a self-tapping screw. The domes serve for screwing, attaching, and/or fixing the cover with screws, rivets, adhesive, expansion plugs, or clips. The motor vehicle roof, guides, ribs, domes, and roller blind shaft holder form a single structural element made of a polymeric material. Preferably, 2 to 15 domes are disposed on both sides near each rib.

The polymeric material preferably contains polyethylene, polypropylene, polystyrene, polyurethanes, polycarbonates, polymethyl methacrylates, polyacrylates, polyesters, polyamides, polyethylene terephthalate, and/or mixtures or copolymers thereof, particularly preferably polycarbonate and polycarbonate blends, such as polycarbonate/polyethylene terephthalate; polycarbonate/acrylonitrile butadiene styrene; polycarbonate/polybutylene terephthalate.

The polymeric material is preferably filled with glass fibers, glass balls, glass beads, and/or mineral grains.

The roof opening constitutes preferably 30% to 80%, preferably 40% to 70% of the roof area of motor vehicle roof.

The roof opening is preferably covered or closed by a transparent or (partially) opaque pane, particularly preferably a transparent or opaque pane capable of being opened. The pane contains preferably glass or polymer, preferably flat glass (float glass), quartz glass, borosilicate glass, soda lime glass, polyethylene, polypropylene, polycarbonate, and/or polymethyl methacrylate.

The covers are preferably attached in the domes by screws, rivets, clips, welds (e.g., ultrasound), latch mechanisms.

The covers preferably contain metals and polymers, particularly preferably aluminum, polyethylene, polypropylene, polystyrene, polyurethanes, polycarbonates, polymethyl methacrylates, polyacrylates, polyesters, polyamides, and/or mixtures or copolymers thereof.

The covers, domes, ribs, or guides can be implemented such that additional functions can be performed by these elements, such as the attachment of the headliner or the interior lighting by screws, adhesive, hanging, clips, or rivets.

The roller blind contains preferably leather, synthetic leather, textile fibers, polymers such as polyethylene, polypropylene, polystyrene, polyurethanes, polycarbonates, polymethyl methacrylates, polyacrylates, polyesters, polyamides, and/or mixtures or copolymers thereof.

The roller blind preferably has a roller blind latch and the motor vehicle roof has a latch opening. The roller blind latch and the latch opening enable additional fixing and closing of the roller blind.

The roller blind roller preferably contains polymers and/or metals, preferably iron, chromium, aluminum, titanium, vanadium, nickel, cobalt, as well as alloys of the metals mentioned or polyethylene, polypropylene, polystyrene, polyurethanes, polycarbonates, polymethyl methacrylates, polyacrylates, polyesters, polyamides, and/or mixtures or copolymers thereof.

The invention further includes a method for producing a motor vehicle roof with an integrated roller blind wherein, in a first step, a motor vehicle roof with a roof opening or a transparent see-through area as well as, in each case, at least 2 guides, 2 ribs, domes, and 2 roller blind shaft holders are injection molded. For this, the conventional methods known to the person skilled in the art, such as thermoplastic injection molding methods, can be used for the injection molding of polymeric materials. Preferably used are 2-component injection molding methods. In an injection mold of the motor vehicle roof, the roof opening, guide, ribs, and domes are formed along with it. The injection mold is then filled with the liquid polymeric material. After curing of the polymeric material, the motor vehicle roof can be removed with at least the formed roof opening, guides, ribs, domes, and roller blind shaft holders. Then, a roller blind roller with roller blind is inserted into the roller blind shaft holders. The roller blind is preferably inserted with the sliding blocks into the guides which is bounded laterally toward the outside by the ribs. By means of a roller blind latch mounted on the roller blind and a latching mechanism (opening) in the motor vehicle roof, the roof opening can be completely closed. The roller blind shaft holders, guides, ribs, and domes are then closed with covers.

The covers are preferably attached to the domes by screws, rivets, expansion plugs, clips, adhesive, and/or welding.

The motor vehicle roof according to the invention is preferably inserted into a vehicle body roof opening.

The invention further includes the use of the motor vehicle roof in cars and/or trucks, tractors, preferably as a regulatable sunroof of a car.

In the following, the invention is explained in detail with reference to drawings. The drawings are purely schematic and not true to scale. The drawings in no way restrict the invention.

They depict:

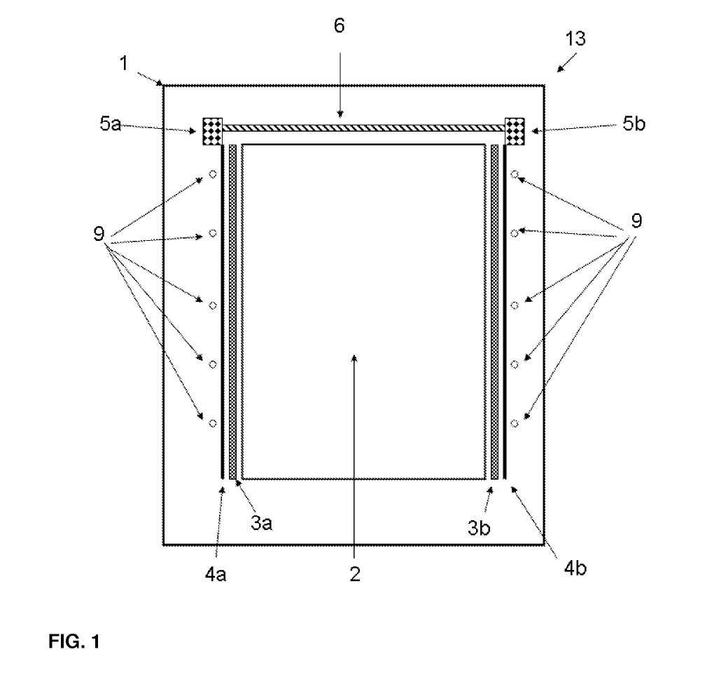

FIG. 1 a view of the motor vehicle roof according to the invention without an inserted roller blind (7) and without covering (8a, 8b),

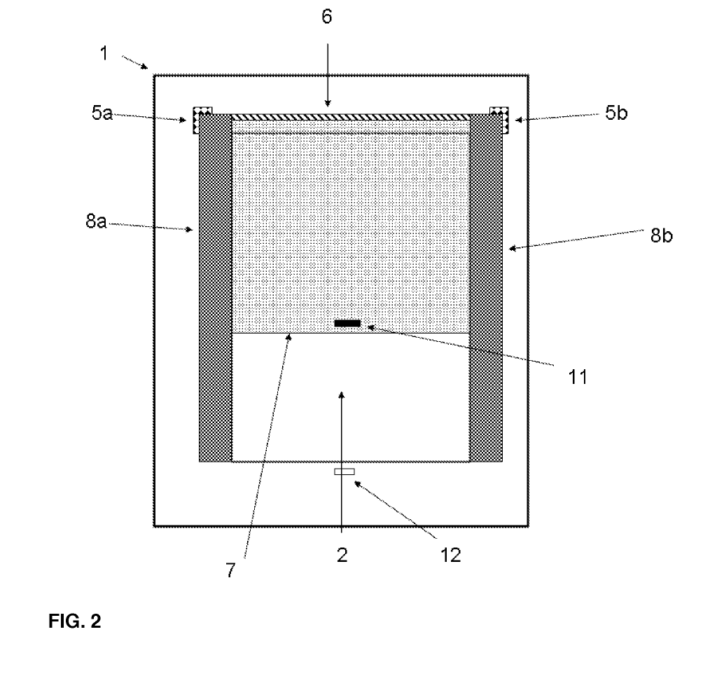

FIG. 2 a view of the completely installed motor vehicle roof, and

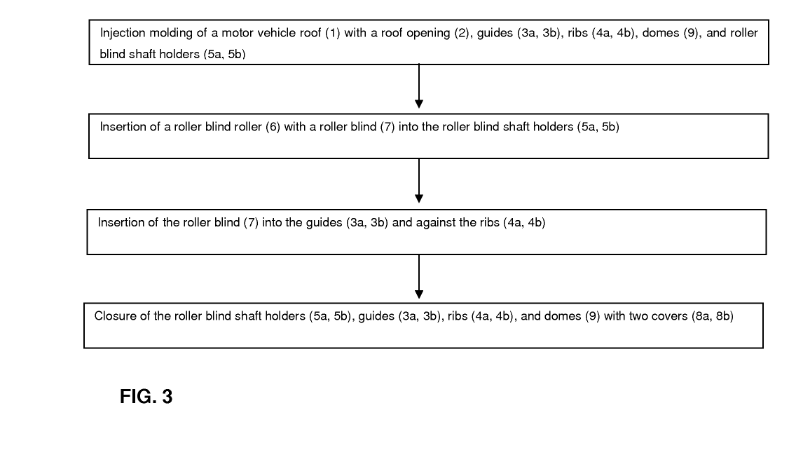

FIG. 3 a flow diagram of the method according to the invention for production of the motor vehicle roof.

FIG. 1 depicts a view of the motor vehicle roof (1) according to the invention without an inserted roller blind (7) and without covering (8a, 8b). The motor vehicle roof (1) comprises a roof opening (2) and, disposed on the left and on the right in the driving direction of the vehicle opposite each other, guides (3a, 3b), ribs (4a, 4b), domes (9), and two roller blind shaft holders (5a, 5b). The motor vehicle roof (1), roof opening (2), guides (3a, 3b), ribs (4a, 4b), domes (9), and the two roller blind shaft holders (5a, 5b) form a single structural element (13) made of a polymeric material, for example, polyolefins. A roller blind roller (6) is inserted into the roller blind shaft holders (5a, 5b).

FIG. 2 depicts a view of the completely installed motor vehicle roof (1). The structure of the motor vehicle roof (1) corresponds to that described in FIG. 1. The guides (3a, 3b), ribs (4a, 4b), domes (9), as well as parts of the roller blind shaft holders (5a, 5b) that cannot be seen are covered by two covers (8a, 8b). The roller blind covers (8a, 8b) are attached to the domes (9) by screws and/or clips. Alternatively, the covers (8a, 8b) can also be attached using an adhesive, preferably moisture-curing or hot-curing adhesive. The covers (8a, 8b) can be adhered on the ribs (4a, 4b), domes (9), or directly on the vehicle. A roller blind (7) wound on the roller blind roller (6) closes a portion of the roof opening (2). By means of a roller blind latch (11) in the roller blind and a latch opening (12) in the motor vehicle roof, the roof opening (2) can be completely closed.

FIG. 3 shows a flow diagram of the method according to the invention for production of the motor vehicle roof. In a first step, a motor vehicle roof (1) with a roof opening (2), guides (3a, 3b), ribs (4a, 4b), domes (9), and roller blind shaft holders (5a, 5b) is injection molded. The temperatures and process conditions are determined by the polymeric material used. After the cooling and, optionally, curing of the polymeric material, the motor vehicle roof (1) can be removed. Then, a roller blind roller (6) with a roller blind (7) is inserted in the roller blind shaft holders (5a, 5b). The roller blind (7) is inserted into the guides (3a, 3b), bounded on the outside by the ribs (4a, 4b). The roller blind shaft holders (5a, 5b), guides (3a, 3b), ribs (4a, 4b), and domes (9) are then closed by two covers (8a, 8b). The closing of the covers (8a, 8b) preferably occurs with the help of screws that fixedly connect the covers (8a, 8b) to a screw thread situated in the domes (9). The number of domes (9) is determined by the size of the roof opening (2) and preferably amounts to 3 to 10 domes (9) per side.

### LIST OF REFERENCE CHARACTERS

(1) Motor vehicle roof
(2) Roof opening
(3a, 3b) Guides
(4a, 4b) Ribs
(5a, 5b) Roller blind shaft holder
(6) Roller blind roller
(7) Roller blind
(8a, 8b) Covers
(9) Domes
(10) Pane
(11) Roller blind latch
(12) Latch opening, and
(13) Structural element

1. A motor vehicle roof with an integrated roller sunroof comprising at least:
a motor vehicle roof having a roof opening;
guides, ribs, and domes mounted on opposite edges of the roof opening on both sides in a longitudinal direction;
roller blind shaft holders and a roller blind roller, the roller blind roller inserted in between the roller blind shaft holders on an upper edge of the roof opening;
a roller blind displaceable on the roller blind roller, the roller blind being positioned along the guides and against the ribs; and
covers enclosing the roller blind shaft holders, the guides, the ribs, and the domes, wherein the motor vehicle roof, the guides, the ribs, the domes, and the roller blind shaft holders form a single structural element made of a polymeric material.

2. The motor vehicle roof according to claim 1, wherein the polymeric material comprises polyethylene, polypropylene, polystyrene, polyurethanes, polycarbonates, polymethyl methacrylates, polyacrylates, polyesters, polyamides, polyethylene terephthalate, and/or mixtures or copolymers thereof.

3. The motor vehicle roof according to claim 1, wherein the roof opening constitutes 30% to 80% of an area of the roof.

4. The motor vehicle roof according to claim 1, further comprising a transparent or opaque pane closing the roof opening.

5. The motor vehicle roof according to claim 4, wherein the pane comprises glass or polymer.

6. The motor vehicle roof according to claim 1, wherein the covers are attached in the domes by screws, rivets, clips, adhesive, expansion plugs, and/or welding.

7. The motor vehicle roof according to claim 1, wherein the covers comprise metals and polymers.

8. The motor vehicle roof according to claim 1, wherein in that the roller blind comprises leather, synthetic leather, textile fibers, polyethylene, polypropylene, polystyrene, polyurethanes, polycarbonates, polymethyl methacrylates, polyacrylates, polyesters, polyamides, and/or mixtures and/or copolymers thereof.

9. The motor vehicle roof according to claim 1, wherein the roller blind comprises lamellar elements.

10. The motor vehicle roof according to claim 1, wherein the roller bind comprises a roller blind latch and the motor vehicle roof has a latch opening.

11. The motor vehicle roof according to claim 1, wherein the roller blind roller comprises polymers and/or metals.

12. A method of producing a motor vehicle roof with an integrated roller blind, the method comprising:
injection molding the motor vehicle roof with a roof opening, guides, ribs, domes, and roller blind shaft holders;
inserting a roller blind roller with a roller blind into the roller blind shaft holders;
inserting the roller blind into the guides against the ribs; and
enclosing the roller blind shaft holders, guides, ribs, and domes with covers.

13. The method according to claim 12, wherein the covers are attached to the domes by screws and/or nails.

14. The method according to claim 12, wherein the motor vehicle roof is inserted into a vehicle body roof opening.

15. A method comprising: using the motor vehicle roof according to claim 1 in cars, trucks, and/or an adjustable sunroof of a car.

16. The motor vehicle roof according to claim 1, wherein the polymeric material comprises polycarbonate and polycarbonate blends, the polycarbonate and polycarbonate blends being polycarbonate/polyethylene terephthalate, polycarbonate/acrylonitrile butadiene styrene, and/or polycarbonate/polybutylene terephthalate.

17. The motor vehicle roof according to claim 3, wherein the roof opening constitutes 40% to 70% of an area of the roof.

18. The motor vehicle roof according to claim 4, wherein the transparent or opaque pane is an openable transparent or opaque pane.

19. The motor vehicle roof according to claim 5, wherein the pane comprises flat glass, quartz glass, borosilicate glass, soda lime glass, polyethylene, polypropylene, polycarbonate, polymethyl methacrylate, and/or mixtures and/or copolymers thereof. (c

20. The motor vehicle roof according to claim 7, wherein the covers comprise aluminum, polyethylene, polypropylene, polystyrene, polyurethanes, polycarbonates, polymethyl methacrylates, polyacrylates, polyesters, polyamides, and/or mixtures or copolymers thereof.

21. The motor vehicle roof according to claim 11, wherein the roller blind roller comprises iron, chromium, aluminum, titanium, vanadium, nickel, cobalt, polyethylene, polypropylene, polystyrene, polyurethanes, polycarbonates, polymethyl methacrylates, polyacrylates, polyesters, polyamides, and/or mixtures, copolymers, and/or composites thereof.
